(19) United States
(12) Patent Application Publication
(10) Pub. No.: US 2017/0140313 A1
(43) Pub. Date: May 18, 2017

(54) METHOD AND APPARATUS TO DETERMINE A ROOT CAUSE FOR A CUSTOMER CONTACT

(71) Applicant: AT&T Intellectual Property I, LP., Atlanta, GA (US)

(72) Inventors: Prabir Nandi, Duluth, GA (US); Sanjeev Devarapalli, Dunwoody, GA (US); Charmaine Williams, Prosper, TX (US)

(21) Appl. No.: 14/941,921

(22) Filed: Nov. 16, 2015

(51) Int. Cl. G06Q 10/06

(52) U.S. Cl. CPC G06Q 10/0637

(57) ABSTRACT

A method, non-transitory computer-readable storage device, and apparatus for determining a root cause for a customer contact or a journey. For example, the method collects data from a plurality of communication channels related to a plurality of touchpoints, determines a plurality of journeys from the plurality of touchpoints, determines a cost for each of the plurality of journeys, selects one journey from the plurality of journeys to determine a root cause for the one journey, wherein the one journey is selected based on the cost calculated for the one journey and a number of traversals for the one journey, determines the root cause for the one journey, and generates a recommendation of a remedial action to address the root cause for the one journey.

The present disclosure relates generally to a method and apparatus to determine a root cause for a customer contact, e.g., determining why a customer has initiated a contact with a service provider.

### BACKGROUND

A user may interact with a service provider via a number of different communication channels, e.g., calling the service provider using a telephone, interacting with a website of the service provider, interacting with an Interactive Voice Response (IVR) system of the service provider, and the like. The service provider is often unable to determine an underlying root cause as to why the customer initiated the interaction with the service provider.

### SUMMARY OF THE DISCLOSURE

In one embodiment, the present disclosure describes a method, non-transitory computer-readable storage device, and apparatus for determining a root cause for a customer contact or a journey. For example, the method collects data from a plurality of communication channels related to a plurality of touchpoints, determines a plurality of journeys from the plurality of touchpoints, determines a cost for each of the plurality of journeys, selects one journey from the plurality of journeys to determine a root cause for the one journey, wherein the one journey is selected based on the cost calculated for the one journey and a number of traversals for the one journey, determines the root cause for the one journey, and generates a recommendation of a remedial action to address the root cause for the one journey.

### BRIEF DESCRIPTION OF THE DRAWINGS

The teaching of the present disclosure can be readily understood by considering the following detailed description in conjunction with the accompanying drawings, in which:

FIG. 1 illustrates an illustrative network related to the present disclosure;

FIG. 2 illustrates an example method of the present disclosure for determining a root cause for a customer contact; and

FIG. 3 depicts a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly describes a method, non-transitory computer-readable storage device, and apparatus for determining an underlying root cause for a customer contact, e.g., determining why a customer has initiated a contact with a service provider. Customer care services are often designed to address various concerns, issues or problems that a user may encounter. For example, a user visiting a provider's website may then follow up with a phone call to a customer care center of the provider (e.g., a product provider or a service provider) to further inquire about particular features of a product or service offered by the provider. Similarly, a customer who has subscribed to a service from a service provider may encounter a problem with the subscribed service and will then call a customer care center of the service provider to discuss the encountered problem. In yet another example, a customer may have an issue with a purchased product from a product provider such as a brick and mortar retailer or an online retailer, and will then call a customer care center of the product provider to discuss the encountered problem. Thus, a provider may deploy any number of customer care communication channels in anticipation that users and customers will likely reach out to the provider for various issues or problems. Providers will incur a substantial cost in deploying and maintaining such customer care communication channels, which are often considered a necessary component of doing business.

As discussed above, a user may interact with a provider, e.g., a service provider, via a number of different communication channels, e.g., calling the service provider using a telephone, interacting with a website of the service provider, interacting with an Interactive Voice Response (IVR) system of the service provider, and the like. However, each communication channel or communication modality used by the user may impart a different financial burden on the service provider, e.g., a toll free telephone call answered by a live customer agent may cost the service provider $7.00, whereas a live online chat answered by a live customer agent may cost the service provider $1.00, whereas each interaction with an IVR system may cost the service provider $0.25, whereas each interaction with a website of the service provider may cost the service provider $0.05, and so on. It should be noted that such costs are only illustrative and can be calculated based on the overall cost for each of the deployed customer care system averaged over a total number of interactions for a defined period of time. For example, a service provider may calculate the total cost (e.g., salaries, employee benefits, rent payments, equipment costs, toll free telephony charges and the like) for deploying a customer care center having 100 live agents at a physical location. In one example, the total cost may be $7,000,000 per month, where the live agents processed 1,000,000 live customer calls, thereby resulting in the cost of $7.00/per call. In another example, a service provider may calculate the total cost (e.g., rent payments, equipment costs, maintenance cost, and the like) for deploying an application server farm having 100 IVR systems at one or more physical locations. In one example, the total cost may be $250,000 per month, where the server farm processed 1,000,000 IVR interactions, thereby resulting in the cost of $0.25/per IVR interaction. Thus, the manner in which the customer contacts the service provider will impact the financial burden of the service provider in meeting the customer care needs of its customers.

Unfortunately, the service provider is often unable to determine the underlying root cause of the customer interaction and the communication channel that will be selected by a customer until the customer has already reached out to the service provider. For example, a user may initiate a telephone call (e.g., a type of communication channel) to the service provider complaining that the user has not received the equipment that was previously indicated to have been shipped to the user. However, the reason that the user has not received the alleged “shipped” equipment is due to the fact that a notification was prematurely sent to the user informing the user of the equipment having been shipped when in fact, the equipment is not even available for shipment for another week. If such notification error were to occur, the service provider may suddenly incur a significant amount of customer care expenses in fielding a significantly larger amount of customer care interactions.

In another example, a user may initiate a telephone call (e.g., a type of communication channel) to the service provider complaining that the user has been charged a late fee on his or her account. However, the reason that the user has been charged the late fee is due to the fact that the user has recently changed his end of billing cycle date, e.g., changing the end of billing cycle date from the 15^{th} day of each month to the 25^{th} day of each month. The software application responsible for applying the late charge may not have been configured to account for such mid-cycle changing of the user's end of billing cycle date. The service provider will likely field the telephone call and address the user's concern by removing the late charge, but the service provider would have incurred the $7.00 customer care charge due the phone call being initiated by the customer. Furthermore, the service provider would also incur the loss of confidence or satisfaction of its customer due to the erroneous application of the late charge even though the customer's concern was ultimately addressed.

It should be noted that the above examples demonstrate two distinct concepts, i.e., the purpose or intent of the customer interaction and the underlying root cause of the customer interaction. For example, the purpose or intent of the customer interaction of the above example may comprise the user not receiving the alleged shipped equipment and a late charge being applied to the customer's account, whereas the respective underlying root causes are the premature sending of the shipment notification and the misapplication of the late charge due to a mid-cycle changing of the customer's end of billing cycle date. In other words, the customer care agent may classify the customer call as having been solved for a shipping issue or a late charge issue, but the customer care agent may not classify the customer call as being resolved for an erroneous shipment notification issue or a software misconfiguration issue. Thus, a service provider may not realize the true extent of the large number of customer care interactions until much later in time when a comprehensive analysis is performed to discover the underlying root causes. Unfortunately, by then, the service provider would have incurred a substantial amount of customer care expenses, in addition to a growing sentiment of dissatisfaction from its customer base.

Thus, a service provider's ability to ascertain the underlying root cause of a customer interaction is often delayed. In other words, the underlying root cause of the user interaction with the service provider is not determined until much later in time with someone analyzing a very large volume of documented customer interactions. Similarly, the modality of the communication that will be used by the user is not anticipated until the user selects a particular modality of communication to reach the service provider.

Broadly, an automated communication channel encompasses any communication modality (e.g., using a mobile application, using a website to perform a transaction, using an Interactive Voice Response (IVR) system, using a messaging service (e.g., an email or a text message) and the like) that does not require a real time interaction with a live person, individual or agent, e.g., a live customer care agent. In contrast, a non-automated communication channel encompasses a real time interaction with a live agent which may include speaking with a live person via a phone call or an online chat.

With the proliferation of many sophisticated automated communication channels, many service providers have reduced the number of customer care agents who are employed at customer care centers. Such reductions are necessary to allow the service provider to gain efficiency, e.g., to reduce the overall cost of providing various services to the customers. However, such cost savings may impact the level of customer care services that the service provider is able to provide to its customers. For example, with a reduced staff of live customer case agents, a service provider may rely on the customers interacting with the many sophisticated automated communication channels to implement transactions and/or to report and resolve possible technical issues specific to the customers. However, some customers may be unwilling to engage these automated communication channels due to personal preferences, lack of technical ability to use these automated communication channels, and/or lack of confidence that such automated communication channels will produce the desired results. Irrespective of the reasons, it is beneficial to promote the adoption of automated communication channels by a customer since such automated communication channels are often available 24 hours a day and are often able to address a customer's issue immediately. Furthermore, the cost associated with the deployment and maintenance of these automated communication channels by the service provider is considerably less than the deployment of live agents in one or more customer care centers. The live agents are often limited in terms of number and the time in which such live agents are available to assist customers. Thus, a customer may be dissatisfied with having to wait a long period of time on the phone to speak with a live agent or is frustrated with having to speak with a live agent only during business hours when such live agents are actively on duty.

It is often the case that the automated communication channels are readily available and are able to address the customer's issues or perform a transaction required by the customer. For example, if the service provider is a network service provider that is providing communication services (e.g., local and/or long distance telephony services, cellular services, email messaging services, text messaging services and the like), data services (e.g., file transferring services, Internet access services and the like), and/or multimedia services (e.g., multimedia content delivery services such as delivering movies, videos, songs, and the like), and/or security services (e.g., home or business security monitoring service), then the customer may have to perform a transaction and/or have an inquiry pertaining to one of the provided services. Such transactions and/or inquiries can often be resolved through automated communication channels without the need to interact with a live agent.

To illustrate, a customer may be traveling out of the country and is attempting to subscribe to an international traveling plan with respect to having a cellular service, a data service and a text messaging service while traveling outside of the country. Such subscription can be handled by a live agent who is contacted by the customer to setup the international traveling plan for a time period selected by the customer. The customer may call a toll free number of the network service provider to speak with a live agent who will setup the international traveling plan for the customer. However, the network service provider may already have a website where such international traveling plan can be automatically subscribed to by any customers without the need to interact with any live agents. In fact, it is often the case that the customer is able to subscribe to such services online faster and with less wasted time than speaking with a live agent.

In another example, a customer may be having a technical issue with a service, e.g., the access speed to the Internet may be an issue. Under this example, a customer may call the network service provider to inquire and/or to complain that the access to the Internet is problematic. In turn, the live agent may have the customer execute a series of tests that will diagnose the potential speed issue raised by the customer. Again, the network service provider may already have a website where such series of tests can be readily accessed by any customers without the need to interact with any live agents. In fact, it is often the case that the customer is able to run these tests online faster and with less wasted time than speaking with a live agent.

In yet another example, a customer may have an issue with a billing issue, e.g., an itemized charge on the bill. Under this example, a customer may call the network service provider to inquire and/or to complain that the itemized charge on the bill may be an error. In turn, the live agent may have the customer specify which itemized charge on the bill is the issue and then provide an explanation as to why the itemized charge on the bill is incurred. Again, the network service provider may already have a website where a comprehensive billing system that can be readily accessed by any customers without the need to interact with any live agents. The billing system may clearly show each itemized charge with a detailed explanation of the incurred charge and allow a customer to investigate each charge online. In other words, supporting documentations can be readily made available online for the customer. Thus, it is often the case that the customer is able to access the billing system online faster and with less wasted time than speaking with a live agent.

However, the unwillingness of a customer to adopt such automated communication channels increases the cost of the network service provider and results in dissatisfaction with the customer having to wait a long period of time before a live agent is made available. Thus, it is beneficial that the customer is encouraged to adopt the use of automated communication channels. However, it is noted that by the time the customer is reaching out to the network service provider via a non-automated communication channels, it would be too late to persuade the customer to use one of the other automated communication channels. In other words, once the customer decides to call the network service provider, it is already too late to persuade the customer to use one of the other automated communication channels. Thus, the type of communication modality used by a user can impact a user's satisfaction with the customer care service of a provider.

In addition to communication modality, the “journey” taken by a user may also impact a user's satisfaction with the customer care service of a provider. To illustrate, a “journey” comprises a series of “touchpoints” between the customer and the service provider. For example, a touchpoint is broadly an interaction between the customer and the service provider. For example, various types of touchpoints may exist, e.g., a marketing touchpoint, an acquisition touchpoint or a use touchpoint. A marketing touchpoint comprises an interaction (e.g., via an automated communication or a non-automated communication channel) pertaining to a marketing event. For example, a marketing touchpoint may comprise a customer visiting a service provider's website to view a marketing offer, a customer calling a service provider to inquire about a new service, a service provider sending an email to the customer offering a new service, a service provider calling the customer to offer a new service, a service provider sending a text message, e.g., an Short Message Service (SMS) message (broadly sending a message directed to the endpoint device of the user), to the customer with a new offer, and the like.

In another example, an acquisition touchpoint comprises an interaction (e.g., via an automated communication or a non-automated communication channel) pertaining to the acquisition of a service. For example, an acquisition touchpoint may comprise a customer visiting a service provider's website to order a service, a customer calling a service provider to order a new service, a service provider sending an email to the customer indicating a date and time when a technician will arrive at the customer's premises to install the new service, a service provider calling the customer to request a time to install the new service, a service provider sending a text message, e.g., an SMS message, to the customer that the new service is now operating, and the like.

In another example, a use touchpoint comprises an interaction (e.g., via an automated communication or a non-automated communication channel) pertaining to the use of a service. For example, a use touchpoint may comprise a customer visiting a service provider's website to view usage parameters relating to a service (e.g., minutes used, cost incurred, and the like), a customer calling a service provider to inquire about the speed of a service, a service provider sending an email to the customer indicating a failure relating to the service that will impact the customer, a service provider calling the customer to fix a piece of equipment relating to an existing service subscribed by the customer, a service provider sending a text message, e.g., an SMS message, to the customer that a current bill for an existing service is overdue, and the like.

In turn, a “journey” traversed by a customer may involve any number of the above described touchpoints. For example, an illustrative journey may involve: 1) the service provider sending an email offer to the customer, 2) responsive to the email offer, the customer visits a website of the service provider, 3) the customer then calls a live agent of the service provider to ask various service related questions, 4) the customer then subscribes to the service using an IVR system of the service provider, 5) the service provider sends a text message to the customer indicating that the service is now provisioned and activated, and 6) the customer reviews a bill online for the newly installed service. In another example, an illustrative journey may involve: 1) the service provider sending an email notice to the customer of an increase in the cost of an existing service, 2) responsive to the increase, the customer visits a website of the service provider, 3) the customer then calls a live agent of the service provider to ask various cost related questions, and 4) the customer then terminates the service using an IVR system of the service provider. In yet another example, an illustrative journey may involve: 1) the service provider sending an email notice to the customer of an opportunity to upgrade an existing service, 2) responsive to the opportunity, the customer visits a website of the service provider, 3) the customer then calls a live agent of the service provider to ask various related questions for the opportunity, 4) the customer then accepts the opportunity for upgrading the existing service on a website of the service provider, 5) the service provider sends a new piece of equipment to the customer via a mail service, 6) the customer activates the newly received equipment and connects to a network of the service provider, 7) the service provider's network detects the newly deployed equipment at the customer's premises and configure the newly deployed equipment remotely, and 8) the service provider sends a text message that the upgraded service has been provisioned and is now activated.

It should be noted that the above described journeys and touchpoints are only illustrative and should not be interpreted as limitations to the present disclosure. It should be noted that each journey may comprise any number of non-automated communication interactions and any number of automated communication interactions between the customer and the service provider. In fact, the “goal” or “intent” of a journey can be achieved via different paths with different starting points or “triggers.” Said another way, the “end” or “destination” of a journey can be arrived through different touchpoints. For example, if the goal of a journey is to activate a new service for a customer, then one path may involve a first customer calling the service provider (e.g., a type of start or trigger) to activate the new service, whereas another customer may visit a website (e.g., another type of start or trigger) of the same service provider to activate the new service. Thus, both journeys of these two illustrative customers arrived at the same destination, but the journeys taken by these two customers are different.

Thus, journeys may encompass any number of goals and intents. For example, journeys may comprise: a billing journey (e.g., a journey that ends in a billing function being performed, e.g., sending a billing, removing a charge, providing an explanation for a billed charge, and the like), an order journey (e.g., a journey that ends in an ordering function being performed, e.g., ordering a service, ordering new equipment to be sent to the customer, upgrading an existing service, adding a feature to an existing service and the like), a service journey (e.g., a journey that ends in a service being performed, e.g., performing a diagnostic test (e.g., a test for reporting low video quality, broadband quality issues, and the like), sending a signal to a customer device (e.g., Residential Gateway (RG) Reachability tests can be used to determine connectivity to the customer premises or customer equipment), sending a technician to perform an onsite test, and the like).

As discussed above, a user may traverse various different types of journeys. However, some journeys can be classified as “expensive” or “costly” journeys versus “non-expensive” or “non-costly” journeys by the service provider. For example, a journey that results in a resolution of a problem or concern of a user via usage of only automated communication channels or modalities can be classified as a “non-expensive” or “non-costly” journey. For example, if the user interacts with the website of the service provider, e.g., interacting with the website on five different instances to resolve a technical problem and the average cost of each interaction with the website is calculated to be $0.05, then the overall cost to the service provider is merely $0.25 to resolve the user's problem.

In another example, a journey that results in a resolution of a problem or concern of a user via usage of only non-automated communication channels or modalities can be classified as an “expensive” or “costly” journey. For example, if the user interacts with the customer care center of the service provider, e.g., interacting with the live agents of the customer care center via a telephone call on five different instances to resolve a technical problem and the average cost of each interaction with the live agent is calculated to be $7.00, then the overall cost to the service provider is $35.00 to resolve the user's problem.

As illustrated above, the relative term “costly” versus “non-costly” can be selectively determined by a provider. In one example, the various demarcations ranging from very costly journeys to non-costly journeys can be set by a service provider, e.g., a journey with a cost over $5.00 is deemed to be “very costly,” a journey with a cost between $4.99-$2.00 is deemed to be “moderately costly,” a journey with a cost between $1.99-$1.00 is deemed to be simply “costly,” a journey with a cost between $0.99-$0.25 is deemed to be “less costly,” and a journey with a cost less than $0.25 is deemed to be “non-costly,” and so on. The above example is merely illustrative and should not be interpreted as a limitation of the present disclosure.

Aside from the communication channels or modalities that are used in the customer interactions, the overall cost of a journey can further be impacted positively or negatively by the outcome of the journey. For example, a journey that comprises interacting with the live agents of the customer care center on five different instances to bring about a customer adopting a new service feature at the subscription rate of $10/month may ultimately be deemed to be a “non-expensive” or “non-costly” journey. In other words, although the five customer interactions or touchpoints of the journey resulted in $35.00 of customer care cost to the service provider, the service provider subsequently received a revenue increase of $120.00/year in newly subscribed services. As such, the cost of this example journey can be calculated on a yearly basis as (−$85.00=$35−$120). The negative sign in this illustrative example is reflective that the service provider still obtained an overall cost benefit of $85.00.

However, in another example, a journey that comprises interacting with only the websites of the service provider on five different instances to bring about a customer dropping a currently subscribed service at the subscription rate of $50/month may ultimately be deemed to be a very “expensive” or “costly” journey. In other words, although the five customer interactions or touchpoints of the journey merely resulted in $0.25 of customer care cost to the service provider, the service provider subsequently received a revenue decrease of $600.00/year in cancellation of previously subscribed services. As such, the cost of this example journey can be calculated on a yearly basis as (+$600.25=$0.25+$600.00). The positive sign in this illustrative example is reflective that the service provider obtained an overall loss of $600.25. It should be noted that the sign of these examples are merely illustrative and are not intended to limit the present disclosure. These examples also illustrate the difficulty in the proper assessment of customer interactions by a service provider.

One aspect of the present disclosure is to detect a “costly” journey and to detect or ascertain a root cause to the “costly” journey with a substantial amount of traversals. In turn, another aspect of the present disclosure is to recommend a remedial action to be taken to address the determined root cause that led to the “costly” journey.

Another aspect of the present disclosure is to gather data from a plurality of touchpoint channels, e.g., telephone call records (e.g., call detail records (CDRs), website access data, email messages, text messages, previous customer care agent interactions, and the like. These historical data can be collected and applied to a learning method for deducing one or more journeys. For example, data for each user can be analyzed across all communication channels for that particular user, e.g., based on the calling phone number of the user, social security number of the user or any other user identifier associated with the user. The analysis will attempt to match the user's various interactions to determine whether the various interactions will fit within one or more particular types of journey destinations. For example, destinations of a journey may comprise: 1) adoption of a new service, 2) adoption of an upgrade to an existing service, 3) termination of an existing service, 4) downgrade of an existing service, 5) request for a replacement equipment, 6) request for a technician to arrive at a customer premises, 7) request to speak to a customer care agent, 8) request to speak to a supervisor customer care agent, 9) posting of a negative comment on a website of the service provider, and so on. As the historical data is processed, one or more paths of various journeys will be uncovered by the automated or machine learning processes. Different paths leading to the same destination of a journey will be identified and analyzed. In one embodiment, these paths are compared to identify costly journeys versus non-costly journeys. In other words, in one implementation, the present method is able to determine the cost of each journey and the number of customers who have traversed each journey based on historical customer care data, e.g., data collected from various customer care interactions.

In one example, the present disclosure is able to quickly discover a new “hot spot” of costly journeys. For example, using the above example where a late charge fee is applied erroneously to bills of customers due to a misconfigured software application, the present disclosure will be able to detect a relatively large number of customers traversing on a costly journey where the end destination is the removal of a late charge fee. Similarly, using the above example where a shipping notification was prematurely sent, the present disclosure will be able to detect a relatively large number of customers traversing on a costly journey where the end destination is a live agent informing the customer that there was in fact no shipping of any equipment to the customer. Thus, the detection of hot spots of various costly journeys enables the present disclosure to continuously monitor customer care interactions to select certain costly journeys to analyze for the underlying root cause.

For example, if a large number of customers has received the premature notice of shipping notification and this underlying root cause is determined, then the present disclosure will be able to provide a recommendation for a remedial action to be taken, e.g., sending another notification that the previously sent premature notice of shipping notification was sent in error and provide a later shipping date in the new notification. This remedial action will likely minimize any further customer interactions where customers will continue to call the service provider inquiring where is the alleged shipped equipment. Thus, the present disclosure will assist a service provider to proactively minimize traversal of costly journeys once the underlying root cause can be determined.

It should be noted that costly journeys may encompass “failed” or “incomplete” journeys that failed to bring about a new stream of revenue for a service provider. For example, a revenue generating journey may comprise: 1) the live agent of a service provider calling a user to discuss a promotion for a service, 2) the user then visits the service provider's website, 3) the user calls the service provider back and speaks with a live agent pertaining to certain features of the service, and 4) the user finally subscribes to the service provider's service 3 days later. However, failed journeys may encompass users who traverse the first two touchpoints or the first three touchpoints, but failed to traverse the last touchpoint to complete the above example journey. The present method is then able to review such failed or incomplete journeys to determine why such failed journeys were prematurely terminated by the users. For example, the website logs of the user interactions can be analyzed to determine what may have dissuaded the users to continue this revenue generating journey, e.g., the user did not see the promotional offer on the website, the user clicked on the wrong links within the website and was sent to a different promotional offer, the time that the user spent on the website indicates an insufficient understanding of the promotional offer, the user provided negative comments on the website, the user's interaction on the website was prematurely terminated by the service provider due to a glitch on the website when the user was using the website, and so on. Alternatively, the customer care logs (e.g., recorded customer care conversations) of the user interactions with the live agents can be analyzed (e.g., comparing the recorded conversation to a predefined agent workflow prepared for handling user inquiries to this service) to determine what may have dissuaded the users to continue this revenue generating journey, e.g., the live agent did not discuss or re-emphasized certain features of the promotional offer listed on the website, the live agent did not discuss or re-emphasized certain cost savings of the promotional offer listed on the website, the live agent did not spend sufficient amount of time with the user to answer the user's questions, the live agent did not adequately address the user's own negative comments or other users' negative comments preciously posted on the website, and so on.

In turn, the present method may further correlate the users' demographics into the analysis, e.g., the age, the gender, the educational level, the media content interest of the users. The analysis may uncover one or more root causes responsible for the failed or incomplete revenue generating journeys and a remedial action can be recommended and then taken. For example, if the analysis uncovers that the live agent has omitted the discussion of a feature of the promotional offer, then the remedial action may comprise amending the workflow to ensure that this feature will be discussed with user during the phone call. For example, if the analysis uncovers that the live agent has omitted to address a previously posted negative comment on a website, then the remedial action may comprise amending the workflow to ensure that a discussion pertaining to the negative comment is addressed by informing the user what measures have since been taken to address the issue raised by the negative comment, e.g., limitation on bandwidth issues, dropped call issues, interference issues, and so on. Thus, the present method is capable of identifying costly journeys pertaining to high operating cost journeys as well as failed revenue generating journeys. In other words, cost may relate to operating cost of the service provider or cost related to a loss of a current revenue stream or loss of a potentially new revenue stream.

For example, customer care interaction records can be stored and applied to machine learning algorithms. For example, the machine learning algorithm may comprise a Gradient Boosted Decision Tree (GBDT) algorithm. However, any other algorithms for machine learning, e.g., a neural network algorithm, may be used.

Prior to being used to perform a prediction for a root cause, the learning algorithm needs to be trained. For example, historical data associated with each type of destination of a journey can be gathered for a plurality of users, e.g., interaction data for each user that ended in the user calling a live agent requesting the status of the user's alleged shipped equipment can be gathered and classified as shipping inquiry historical data. Similarly, interaction data for each user that ended in the user requesting a live agent to remove a late charge can be gathered and classified as requesting for live agent to remove late charge historical data. Thus, a large volume of user interactions can be classified and sorted into different sets of historical data sets that can be used as training sets for machine learning algorithms. In one example, each set of historical data can be divided such that one half of the historical data is used to train the machine learning algorithm and the remaining half of the historical data is used to test the machine learning algorithms to determine whether the machine learning algorithms are making the correct predictions for root causes.

In turn, once the machine learning algorithms are trained and tested, the machine learning algorithms are deployed to monitor the interactions of each user, e.g., monitoring for each user the interaction of the user with the service providers across a plurality of communication channels or modalities. In turn, the monitoring includes computing the above mentioned costs for a plurality of journeys to determine “hot spots” for costly journeys. In turn, potential roots causes are detected and recommendations for remedial actions can be automatically provided.

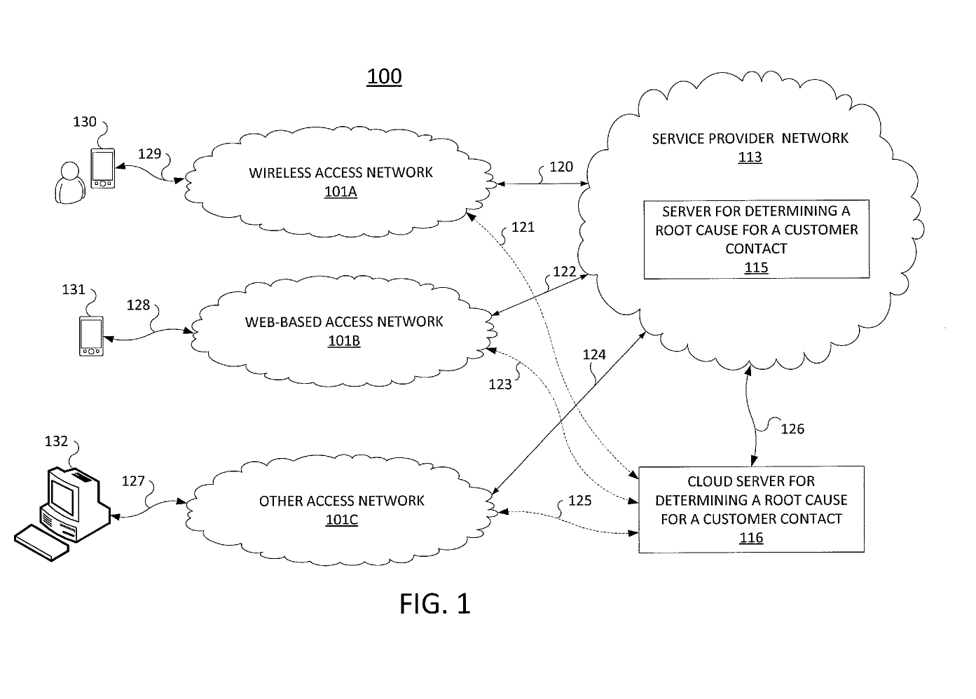

FIG. 1 illustrates an exemplary network 100 related to the present disclosure. In one illustrative embodiment, the network 100 comprises a wireless access network 101a (e.g., a cellular access network, a wireless fidelity (Wi-Fi) access network and the like), a web-based access network 101b (e.g., an Internet-based access network), other access network 101c (e.g., a telephony access network, a Voice over Internet Protocol (VoIP) access network, and the like), and a core service provider network 113 (or broadly a core network). The wireless access network 101a may comprise any number of wireless access networks, e.g., Wi-Fi networks, 2G networks, 3G networks, LTE networks, satellite network, etc. The core network 113 may comprise any number of application servers, gateway devices, routers, switches, databases, firewalls etc. of a network service provider (not shown). For example, the core network 113 may comprise an application server 115 for determining a root cause for a customer contact or a journey, e.g., a dedicated database server can be deployed to monitor users' interaction with a service provider for determining a root cause for a customer contact or a journey. The core network 113 may also be communicatively coupled to one or more cloud servers 116. The method of the present disclosure may be implemented in a server of a service provider network, e.g., server 115, or a cloud server, e.g., server 116, of the present disclosure. The access networks 101a-101c communicate with application servers 115 and/or 116 via various types of communication channels 120-126.

Although the teachings of the present disclosure are discussed below in the context of a core network, the teaching is not so limited. Namely, the teachings of the present disclosure can be applied in any types of wireless networks (e.g., 2G network, 3G network, a long term evolution (LTE) network, and the like) or any types of wire based networks (e.g., public switched telephone network, Internet Protocol (IP) networks, cable networks, etc.), wherein promoting the adoption of a digital communication channel by a user, is beneficial.

FIG. 1 also illustrates various user endpoint devices 130-132. The user endpoint devices 130-131 access services via the wireless access network 101a or the web-based access network 101b via various types of communication channels 128-129. The user endpoint device 132 accesses services via the other access network 101c (e.g., a fiber optic network, a cable network, etc.) via various types of communication channels 127. It should be noted that the network 100 is only illustrative and the number of network components or elements are not specifically limited as shown. Any number of network elements and components can be deployed. For example, there may be several wireless networks, several wire based access networks, several different core networks, several cloud servers, and the like. In addition, any number of network elements may be deployed in each of the networks.

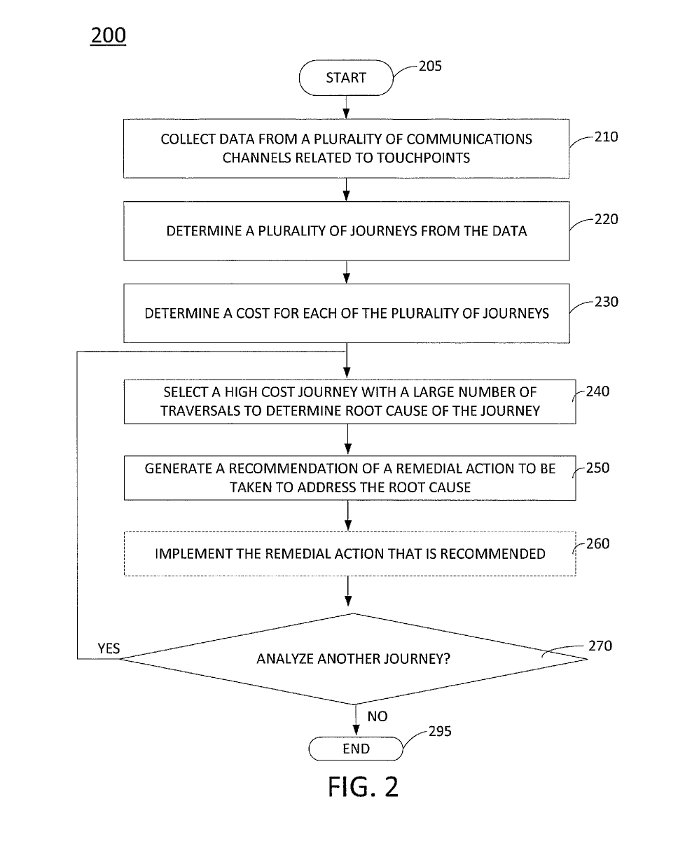

FIG. 2 illustrates a flowchart of an example method 200 of the present disclosure for determining a root cause for a customer contact or for a journey. For example, the method may be implemented in a dedicated server, e.g., an application server of a network service provider, a cloud server, etc. Method 200 starts in step 205 and proceeds to step 210.

In step 210, method 200 collects data from a plurality of communication channels related to touchpoints. For example, method 200 collects historical data from a plurality of different communication channels (e.g., digital communication channels and non-digital communication channels) for a plurality of different touchpoints.

In step 220, method 200 determines a plurality of journeys from the collected data. For example, the method 200 may employ a machine learning algorithm or a neural network to learn a plurality of possible journeys. In fact, different paths leading to the same journey destinations are noted as are the number of touchpoints of each possible path including the number of touchpoints comprising automated communication channels versus the number of touchpoints comprising non-automated communication channels.

In step 230, method 200 determines a cost for each of the determined journeys. For example, the cost for each of the touchpoints can be predetermined based on the cost that is incurred to provide the necessary resources for interacting with the customer at each of the touchpoints, e.g., the cost for interacting with a customer via a website, via an IVR, via an online chat, via a live chat with an agent, and so on. In turn, the cost for each journey can be determined by summing the cost of all of the touchpoints within each journey.

In step 240, method 200 selects a high cost journey with a large number of traversals from the plurality of journeys to determine a root cause for the selected journey. For example, once the cost for each journey has been calculated, method 200 can rank the plurality of journeys based on their calculated costs, e.g., highest to the lowest. Thus, the relative term “high cost” or “low cost” for a journey is relative to the calculated costs of other journeys. Furthermore, the number of traversals for each of the journeys (e.g., the total number of customers who traveled on each journey) are also tallied. Thus, as customer interactions are continuously classified or accounted for into the plurality of journeys, hot spots for costly journeys will be revealed. Such hot spots of costly journeys can be targeted for analysis by the machine learning algorithms. For example, a hot spot of costly journeys ending in the user calling a live agent requesting the status of the user's alleged shipped equipment can be automatically detected as an anomaly. The machine learning algorithms can be trained on recorded comments provided by the customers during the customer care interactions (e.g., a recording of the customer's discussion with the live agent can be recorded). For example, the machine learning algorithms may be able to detect that the underlying root cause was a premature shipping notification being sent by scanning for common terms from a large number of recordings for the same type of journey.

In step 250, method 200 generates a recommendation for a remedial action. For example, if the underlying root cause was a premature shipping notification being sent, then the recommendation(s) may comprise: sending another notification (e.g., an electronic notification such as an email, a text message such as a SMS message, a posting on a website of the service provider and the like) informing all customers that the previously sent notification was sent in error, creating an IVR message informing any calling customer of the error (e.g., generating an interactive voice response message to be played by an interactive voice response system to a calling customer), accelerating the shipping date of the equipment, and so on. For example, if the underlying root cause was an improperly configured software application that assessed an improper late charge, then the recommendation(s) may comprise: sending a notification informing all impacted customers that the previously sent notification of a late charge in their bills was sent in error, creating an IVR message informing any calling customer of the late charge error and its subsequent removal, sending a revised bill to the impacted customers with the late charge being removed, sending a text message apologizing for the late charge billing error, and so on.

In optional step 260, method 200 optionally implements the recommended remedial action. For example, the one or more recommended remedial actions may need to be approved by a customer care supervisor. Once notified of the potential root cause, the customer care supervisor may authorize one of the recommended remedial action to be implemented, e.g., sending a notification to the impacted customers. The method 200 may send the electronic notification in step 260 to all the impacted customers.

In step 270, method 200 determines whether another journey is to be analyzed. For example, method 200 may start from the top of the list of journeys with the highest calculated costs and proceed to the next lower cost journey. Each journey is then analyzed for its possible underlying root cause. If another journey is to be analyzed, method 200 returns to step 240 to select another journey for analysis. If no further journey is to be analyzed, method 200 ends in step 295.

It should be noted that method 200 may operate continually. Namely, the descriptions of method 200 having a start step 205 and an end step 295 are not to be interpreted as limitations of the present disclosure.

It should be noted that the method 200 is described in view of a single journey being analyzed. However, the method is not so limited. The method can be implemented in parallel for a plurality of journeys being analyzed.

It should be noted that although not explicitly specified, one or more steps, functions, or operations of the method 200 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 2 that recite a determining operation, or involve a decision, do not necessarily require that both branches of the determining operation be practiced. In other words, one of the branches of the determining operation can be deemed as an optional step.

As such, the present disclosure provides at least one advancement in the technical field of automated customer service by providing a proactive customer care service. This advancement is in addition to the traditional interaction of users with the service provider. In other words, the present disclosure provides a dedicated application server 115 or 116 that is configured to perform the specific functions as discussed in FIG. 2 and is tasked with for determining a root cause for a customer contact or for a journey. Such adoption of a proactive customer care service will reduce the overall cost of the network service provider and enhances the overall satisfaction of the customer.

The present disclosure also provides a transformation of customer interaction data. For example, historical customer interaction data is transformed into recommendation data and/or remedial actions that can be used to reduce the overall cost of the network service provider and enhances the overall satisfaction of the customer.

Finally, embodiments of the present disclosure improve the functioning of a computing device, e.g., a dedicated customer care application server. Namely, a dedicated customer care application server is improved by utilizing historical customer interaction data to quickly detect hot spots of costly journeys being traversed by customers.

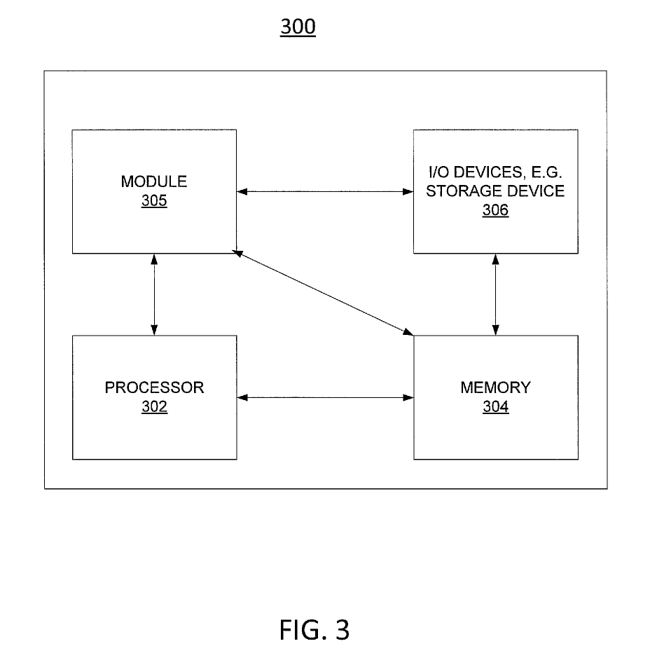

FIG. 3 depicts a high-level block diagram of a computer, e.g., a dedicated application server, suitable for use in performing the functions described herein. As depicted in FIG. 3, the system 300 comprises one or more hardware processor elements 302 (e.g., a central processing unit (CPU), a microprocessor, or a multi-core processor), a memory 304, e.g., random access memory (RAM) and/or read only memory (ROM), a module 305 for determining a root cause for a customer contact or for a journey, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method 200 as discussed above is implemented in a distributed or parallel manner for a particular illustrative example, i.e., the steps of the above method 200, or the entire method 200 is implemented across multiple or parallel computers, then the computer of this figure is intended to represent each of those multiple computers.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computer or any other hardware equivalents, e.g., computer readable instructions pertaining to the method(s) discussed above can be used to configure a hardware processor to perform the steps, functions and/or operations of the above disclosed method. In one embodiment, instructions and data for the present module or process 305 for determining a root cause for a customer contact or for a journey (e.g., a software program comprising computer-executable instructions) can be loaded into memory 304 and executed by hardware processor element 302 to implement the steps, functions or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for determining a root cause for a customer contact or for a journey (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A method comprising:
collecting, by a processor, data from a plurality of communication channels related to a plurality of touchpoints;
determining, by the processor, a plurality of journeys from the plurality of touchpoints,
determining, by the processor, a cost for each of the plurality of journeys;
selecting, by the processor, one journey from the plurality of journeys to determine a root cause for the one journey, wherein the one journey is selected based on the cost calculated for the one journey and a number of traversals for the one journey;
determining, by the processor, the root cause for the one journey; and
generating, by the processor, a recommendation of a remedial action to address the root cause for the one journey.

2. The method of claim 1, further comprising:
implementing the remedial action by a service provider.

3. The method of claim 2, wherein the service provider comprises a network service provider.

4. The method of claim 1, wherein the remedial action comprises sending an electronic notification.

5. The method of claim 1, wherein the remedial action comprises generating an interactive voice response message to be played by an interactive voice response system.

6. The method of claim 1, wherein the processor is deployed in a network of a network service provider.

7. The method of claim 6, wherein the network service provider provides at least one of: a communication service, a data service, or a multimedia service.

8. A tangible computer-readable storage device storing a plurality of instructions which, when executed by a processor, cause the processor to perform operations, the operations comprising:
collecting data from a plurality of communication channels related to a plurality of touchpoints;
determining a plurality of journeys from the plurality of touchpoints,
determining a cost for each of the plurality of journeys;
selecting one journey from the plurality of journeys to determine a root cause for the one journey, wherein the one journey is selected based on the cost calculated for the one journey and a number of traversals for the one journey;
determining the root cause for the one journey; and
generating a recommendation of a remedial action to address the root cause for the one journey.

9. The tangible computer-readable storage device of claim 8, further comprising:
implementing the remedial action by a service provider.

10. The tangible computer-readable storage device of claim 9, wherein the service provider comprises a network service provider.

11. The tangible computer-readable storage device of claim 10, wherein the remedial action comprises sending an electronic notification.

12. The tangible computer-readable storage device of claim 8, wherein the remedial action comprises generating an interactive voice response message to be played by an interactive voice response system.

13. The tangible computer-readable storage device of claim 8, wherein the processor is deployed in a network of a network service provider.

14. The tangible computer-readable storage device of claim 13, wherein the network service provider provides at least one of: a communication service, a data service, or a multimedia service.

15. An apparatus comprising:
a processor; and
a computer-readable storage device storing a plurality of instructions which, when executed by the processor, cause the processor to perform operations, the operations comprising:
collecting data from a plurality of communication channels related to a plurality of touchpoints;
determining a plurality of journeys from the plurality of touchpoints,
determining a cost for each of the plurality of journeys;
selecting one journey from the plurality of journeys to determine a root cause for the one journey, wherein the one journey is selected based on the cost calculated for the one journey and a number of traversals for the one journey;
determining the root cause for the one journey; and
generating a recommendation of a remedial action to address the root cause for the one journey.

16. The apparatus of claim 15, further comprising:
implementing the remedial action by a service provider.

17. The apparatus of claim 16, wherein the service provider comprises a network service provider.

18. The apparatus of claim 15, wherein the remedial action comprises sending an electronic notification.

19. The apparatus of claim 15, wherein the remedial action comprises generating an interactive voice response message to be played by an interactive voice response system.

20. The apparatus of claim 15, wherein the processor is deployed in a network of a network service provider, wherein the network service provider provides at least one of: a communication service, a data service, or a multimedia service.
